(19) United States
(12) Patent Application Publication
(10) Pub. No.: US 2025/0296240 A1
(43) Pub. Date: Sep. 25, 2025

(54) ROBOT HAND AND ROBOT

(71) Applicants: NGK INSULATORS, LTD., Nagoya-Shi (JP); NGK KILNTECH, CORPORATION, Nagoya-Shi (JP)

(72) Inventors: Kazuya NARUMIYA, Nagoya-Shi (JP); Takeshi KOMAKI, Nagoya-Shi (JP); Terukazu IWATA, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 19/081,241

(22) Filed: Mar. 17, 2025

(30) Foreign Application Priority Data
Mar. 21, 2024 (JP) 2024-044630

(51) Int. Cl. B25J 11/00; B25J 19/00

(52) U.S. Cl. CPC B25J 11/005; B25J 19/0054

(57) ABSTRACT

A robot hand may include a hand arm unit for holding a saggar conveyed out from a heat treatment furnace and a cooling mechanism for cooling the hand arm unit. A robot may include a robot arm and the robot hand attached to the robot arm and configured to hold the saggar conveyed out from the heat treatment furnace.

### REFERENCE TO RELATED APPLICATION

This application claims priority to Japanese Patent Application No. 2024-44630 filed on Mar. 21, 2024. The entire content of the priority application is incorporated herein by reference

### TECHNICAL FIELD

The disclosure herein relates to a robot hand and a robot.

### BACKGROUND ART

Japanese Patent No. 6949260 describes a robot hand. The robot hand holds a saggar using a hand arm unit after the saggar has been conveyed out from a heat treatment furnace.

The above robot hand holds a high-temperature saggar with the hand arm unit. Thus, the hand arm unit may be heated, leading to a malfunction of the robot hand.

### SUMMARY

The disclosure herein provides a technology that prevents occurrence of malfunction of a robot hand due to a hand arm unit being heated.

In a first aspect of the art disclosed herein, a robot hand may comprise a hand arm unit for holding a saggar conveyed out from a heat treatment furnace and a cooling mechanism for cooling the hand arm unit.

According to the configuration above, the hand arm unit is cooled by the cooling mechanism. Thus, the configuration above prevents the hand arm unit from having a high temperature even when the hand arm unit holds a high-temperature saggar, thereby preventing occurrence of malfunction of the robot hand.

In a tenth aspect of the art disclosed herein, a robot may comprise a robot arm and a robot hand attached to the robot arm and configured to hold a saggar conveyed out from a heat treatment furnace. The robot hand may comprise a hand arm unit for holding the saggar and a cooling mechanism for cooling the hand arm unit.

The configuration above produces the same effects as those of the above-described robot hand.

### BRIEF DESCRIPTION OF DRAWINGS

FIG. 1 is a schematic cross-sectional view of a heat treatment system according to a first embodiment.

FIG. 2 is a schematic diagram of the heat treatment system according to the first embodiment.

FIG. 3 is a perspective view of a robot hand according to the first embodiment.

FIG. 4 is a perspective view of a right hand arm unit of the robot hand according to the first embodiment.

FIG. 5 is a cross-sectional view of the right hand arm unit/a left hand arm unit and a cooling mechanism, where first and second right pressing members/first and second left pressing members are at their second positions.

FIG. 6 is a perspective view of the left hand arm unit of the robot hand according to the first embodiment.

FIG. 7 is a cross-sectional view of the right hand arm unit/the left hand arm unit and the cooling mechanism, where the first and second right pressing members/the first and second left pressing members are at their first positions.

FIG. 8 is a cross-sectional view of a saggar and a hand arm when a shatter is at an open position in the first embodiment.

FIG. 9 is a cross-sectional view of the saggar and the hand arm when the shatter is at a closed position in the first embodiment.

FIG. 10 is a top view of a saggar and hand arms after a preparation step in the first embodiment.

FIG. 11 is a top view of the saggar and the hand arms after a first holding step or a second holding step in the first embodiment.

FIG. 12 is a side view of the saggar and a hand arm after the first holding step or the second holding step in the first embodiment.

FIG. 13 is a side view of the saggar and the hand arm after a lifting step in the first embodiment.

FIG. 14 is a side view of the saggar and the hand arm after a positioning step in the first embodiment.

FIG. 15 is a side view of the saggar and the hand arm after a first inverting step in the first embodiment.

FIG. 16 is a side view of the saggar and the hand arm after a second moving step in the first embodiment.

FIG. 17 is a side view of the saggar and the hand arm after a hold releasing step in the first embodiment.

FIG. 18 is a side view of the saggar and the hand arm after a first holding step in a second embodiment.

FIG. 19 is a top view of hand arms according to the second embodiment.

FIG. 20 is a side view of a saggar and a hand arm before second and third right pressing members and second and third left pressing members move in a positioning step in the second embodiment.

FIG. 21 is a side view of the saggar and the hand arm after the positioning step in the second embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved robot hands and robots as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the art disclosed herein according to the above first aspect, the cooling mechanism may be located in the hand arm unit. This configuration further prevents the hand arm unit from having a high temperature.

In a third aspect of the art disclosed herein according to the above first or second aspect, the hand arm unit may comprise a hand arm including a first opening, a second opening, and an internal space. The cooling mechanism may comprise a supply device that is attached to the first opening, supplies a fluid to the internal space through the first opening, and discharges the fluid from the internal space through the second opening. In this configuration, the fluid flows into the internal space through the first opening, flows through the internal space, and is then discharged to the outside of the hand arm unit through the second opening. This increases cooling efficiency for the hand arm unit.

In a fourth aspect of the art disclosed herein according to the above third aspect, the hand arm unit may further comprise a contact member configured to contact the saggar when the hand arm unit holds the saggar. The hand arm may comprise a first wall to which the contact member is attached and a second wall in which the first opening is formed. The second wall may be different from the first wall. This configuration prevents the supply device attached to the first opening from bumping into the saggar.

In a fifth aspect of the art disclosed herein according to the above fourth aspect, the supply device may be attached to the second opening, and the second opening may be formed in the second wall. This configuration further prevents the supply device from bumping into the saggar.

In a sixth aspect of the art disclosed herein according to any one of the above third to fifth aspects, the fluid may be a cooling gas or compressed air. This prevents the hand arm unit from having a high temperature with a simple configuration.

In a seventh aspect of the art disclosed herein according to any one of the above first to sixth aspects, the robot hand may further comprise a base supporting the hand arm unit and an attachment member configured to attach the base to a robot arm. A thermal conductivity of the attachment member may be lower than a thermal conductivity of the base. This configuration suppresses the heat of the hand arm unit from transferring to the robot arm.

In an eighth aspect of the art disclosed herein according to the above seventh aspect, the robot hand may further comprise a heat shielding member positioned between the saggar and the base when the saggar is held by the hand arm unit. This configuration suppresses the heat of the saggar from directly transferring to the base.

In a ninth aspect of the art disclosed herein according to the above eighth aspect, the heat shielding member may be attached to the base. This configuration prevents displacement of the heat shielding member from a position between the saggar and the base.

### First Embodiment

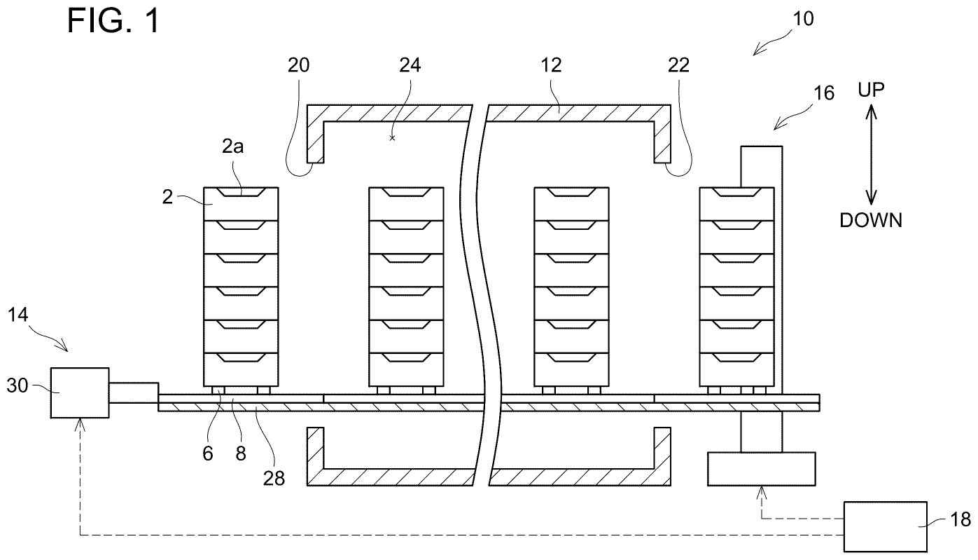

As shown in FIG. 1, a heat treatment system 10 comprises a heat treatment furnace 12, a conveyor device 14, a robot 16, and a controller 18.

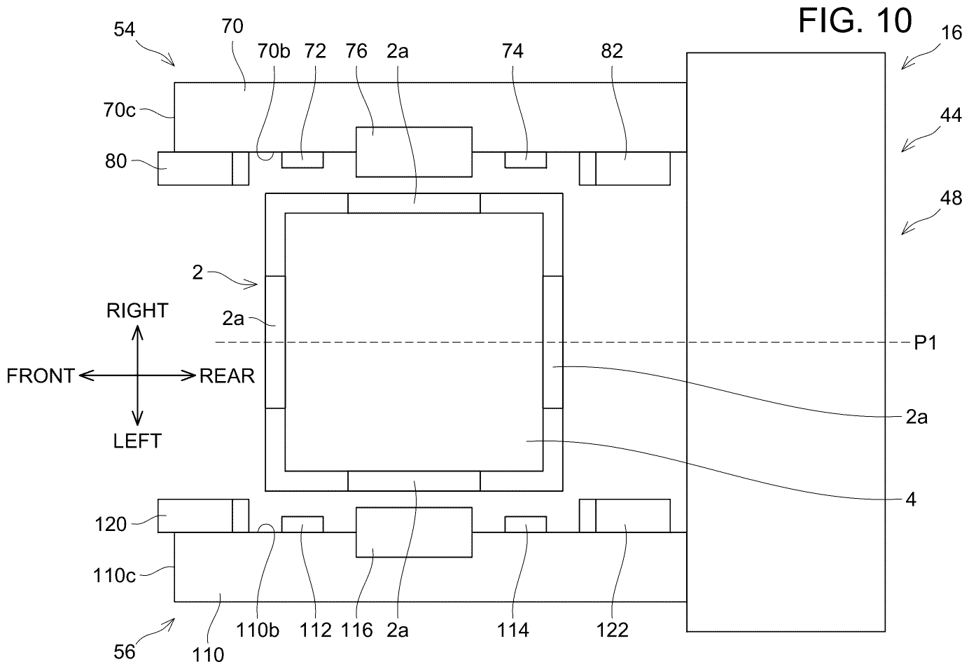

The heat treatment furnace 12 heat treats a material 4 (see FIG. 10) in saggars 2. Each saggar 2 has a substantially cuboid box shape with an open upper end. Each saggar 2 includes a plurality of notches 2a. The notches 2a are formed in four side walls of each saggar 2, respectively. Two notches 2a are opposite to each other, and the other two notches 2a are opposite to each other. The notches 2a are located in an upper portion of each saggar 2. The notches 2a communicate the inside of each saggar 2 with the outside thereof. The saggars 2 are stacked on top of each other. The saggars 2 are placed on a bedplate 8 via spacers 6. Thus, the lowest saggar 2 in a stack of saggars 2 is separated from the bedplate 8 and is not in contact with the bedplate 8. The material 4 to be heat treated is, for example, a raw material for ceramic capacitor or a material for positive electrode or negative electrode of a lithium-ion battery.

The heat treatment furnace 12 is a substantially cuboid-shaped heat-insulating structure. The heat treatment furnace 12 comprises an entrance 20, an exit 22 opposite to the entrance 20, and a heat treatment space 24. The heat treatment space 24 communicates with the space outside the heat treatment furnace 12 through the entrance 20 and the exit 22.

The conveyor device 14 comprises a guide member 28 and a pusher 30. The guide member 28 is located across the heat treatment space 24 and the space outside the heat treatment furnace 12. The bedplate 8 is placed on the guide member 28. The pusher 30 is configured to push the bedplate 8 on the guide member 28. The pusher 30 repeatedly pushes the bedplate 8 according to control by the controller 18, and the bedplate 8 is thereby moved and guided by the guide member 28. The saggars 2 and the bedplate 8 are conveyed from the space outside the heat treatment furnace 12 into the heat treatment space 24 through the entrance 20, pass through the heat treatment space 24, and are then conveyed out from the heat treatment space 24 to the space outside the heat treatment furnace 12 through the exit 22. The material 4 in the saggars 2 is fired (i.e., heat treated) by heaters (not shown) in the heat treatment space 24 while the saggars 2 are passing through the heat treatment space 24.

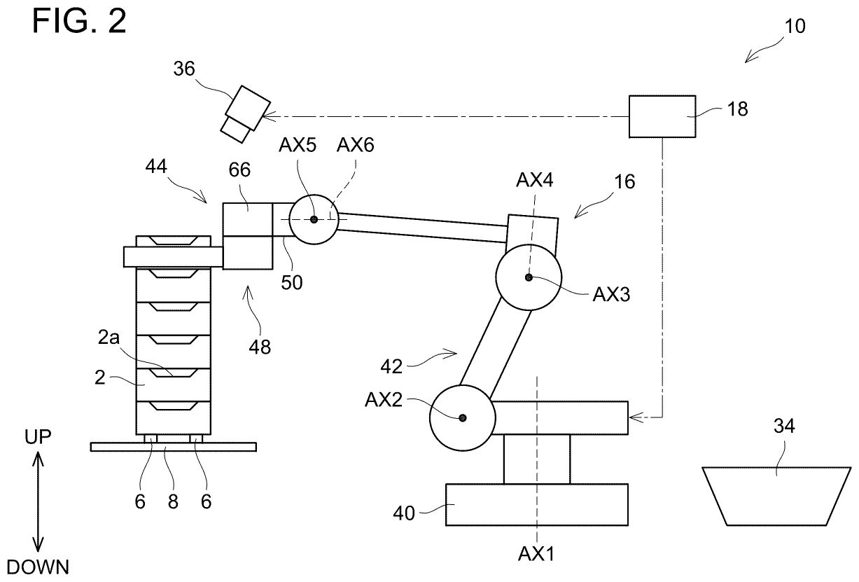

The robot 16 is located in the space outside the heat treatment furnace 12. The robot 16 is located near the exit 22. As shown in FIG. 2, the robot 16 holds a saggar 2 conveyed out from the exit 22 and moves the saggar 2 such that the heat-treated material 4 in the saggar 2 can be recovered into a recovery container 34. The controller 18 controls the robot 16 based on the position and orientation of a saggar 2 detected by a saggar detector 36. For example, the saggar detector 36 is a camera.

The robot 16 is an articulated robot. The robot 16 comprises a base 40, a robot arm 42, and a robot hand 44. The robot arm 42 is mounted on the base 40. For example, the robot arm 42 is an articulated hexaxial robot arm. The robot arm 42 is rotatable about an axis AX1 extending in an up-down direction, rotatable about an axis AX2 extending substantially perpendicular to the up-down direction, rotatable about an axis AX3 extending substantially perpendicular to the up-down direction, rotatable about an axis AX4 extending substantially perpendicular to the axis AX3, rotatable about an axis AX5 extending substantially perpendicular to the up-down direction, and rotatable about an axis AX6 extending perpendicular to the axis AX5. The rotation of the robot arm 42 adjusts the position and orientation of the robot hand 44. It should be noted that axes about which the robot arm 42 rotates are not limited to the axes mentioned above.

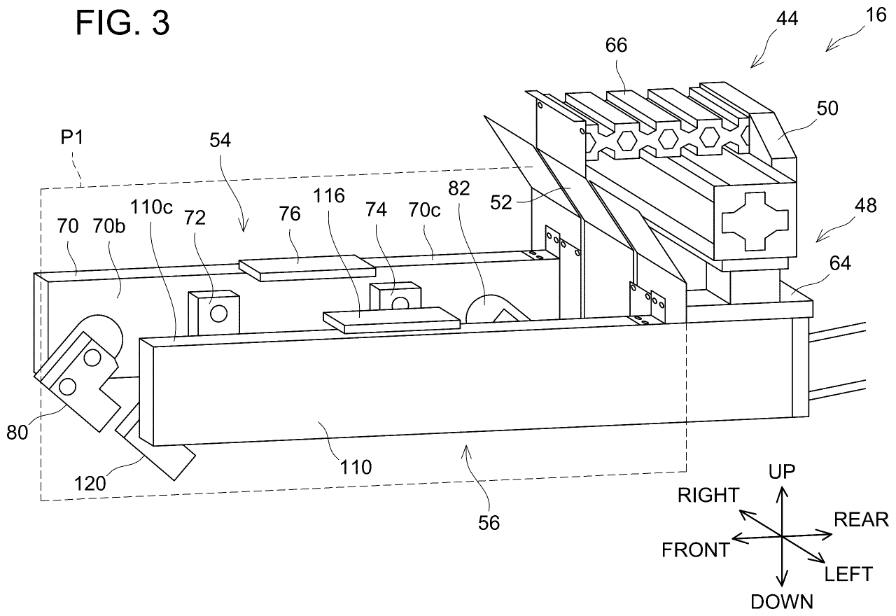

The robot hand 44 is mounted on the distal end of the robot arm 42. The robot hand 44 holds a saggar 2. As shown in FIG. 3, the robot hand 44 comprises a base 48, an attachment member 50, a heat shielding member 52, and a pair of hand arm units 54, 56. In the following description for the robot hand 44, a direction in which the hand arm units 54, 56 extend is termed a front-rear direction, a direction perpendicular to the front-rear direction is termed an up-down direction, and a direction perpendicular to the front-rear direction and the up-down direction is termed a left-right direction.

The base 48 comprises an arm support 64 and a frame 66. The arm support 64 supports the pair of hand arm units 54, 56. For example, the arm support 64 is constituted of a metal material. The arm support 64 extends in the left-right direction.

The frame 66 is attached to the upper end of the arm support 64. For example, the frame 66 is constituted of a metal material. For example, this metal material is aluminum. The frame 66 is hollow. This allows for a reduction in the weight of the frame 66 compared to a frame 66 that is not hollow.

The attachment member 50 is attached to the rear end of the frame 66. The attachment member 50 allows the frame 66 to be mounted to the distal end of the robot arm 42 (see FIG. 2). The attachment member 50 is located between the frame 66 and the robot arm 42. For example, the attachment member 50 is constituted of a cement-based material or a calcium silicate-based material. A thermal conductivity of the attachment member 50 is lower than thermal conductivities of the arm support 64 and the frame 66 (i.e., a thermal conductivity of the base 48). This suppresses the heat of a saggar 2 from transferring from the base 48 to the robot arm 42 through the attachment member 50. The attachment member 50 may comprise a metal member and a heat-insulating sheet interposed between the metal member and the distal end of the robot arm 42.

The heat shielding member 52 is attached to the front end of the arm support 64 and the front end of the frame 66. The heat shielding member 52 has a plate shape. For example, the heat shielding member 52 is constituted of a metal material. For example, this metal material is stainless steel. While the robot hand 44 is holding a saggar 2 (see FIG. 2), the heat shielding member 52 is interposed between the saggar 2 and the arm support 64 and is spaced apart from the saggar 2. This suppresses transfer of radiation heat from the saggar 2 to the arm support 64 and the frame 66. The heat shielding member 52 may comprise a metal member and a heat-insulating material disposed on a surface of the metal member that faces the saggar 2.

The pair of hand arm units 54, 56 comprises a right hand arm unit 54 and a left hand arm unit 56. The right hand arm unit 54 and the left hand arm unit 56 are spaced apart from each other in the left-right direction. The right hand arm unit 54 is in a plane-symmetrical relationship with the left hand arm unit 56 with respect to an imaginary plane P1. The imaginary plane PI is a plane on which the up-down direction and the front-rear direction lie and passes through the center of the robot hand 44 in the left-right direction.

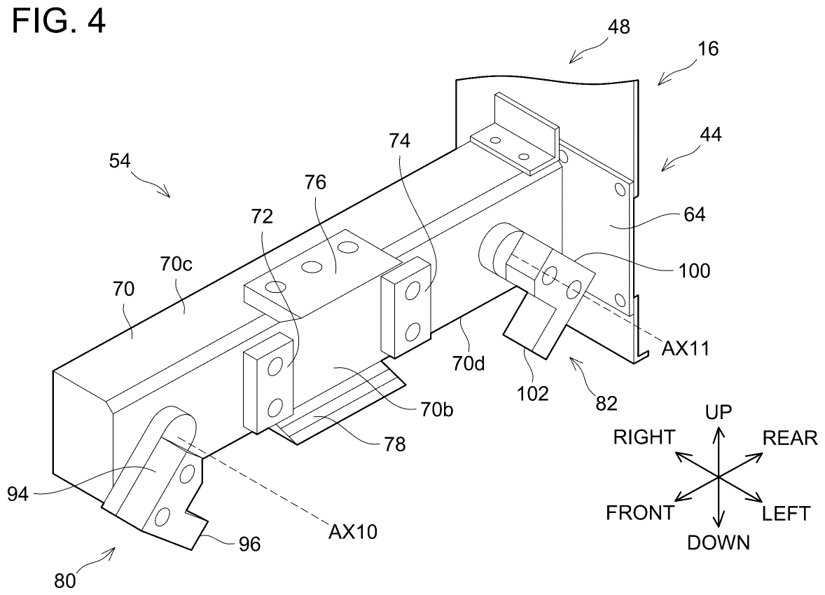

As shown in FIG. 4, the right hand arm unit 54 comprises a right hand arm 70, a first right holding member 72, a second right holding member 74, a first right claw 76, a second right claw 78, a first right pressing member 80, and a second right pressing member 82.

For example, the right hand arm 70 is constituted of a metal material. This allows the right hand arm 70 to have increased strength. For example, the metal material is stainless steel or aluminum. The right hand arm 70 has a substantially cuboid shape. The right hand arm 70 extends forward from the arm support 64. The right hand arm 70 is movable in the left-right direction relative to the arm support 64. The right hand arm 70 is moved by the controller 18 (see FIG. 2) controlling an arm actuator (not shown).

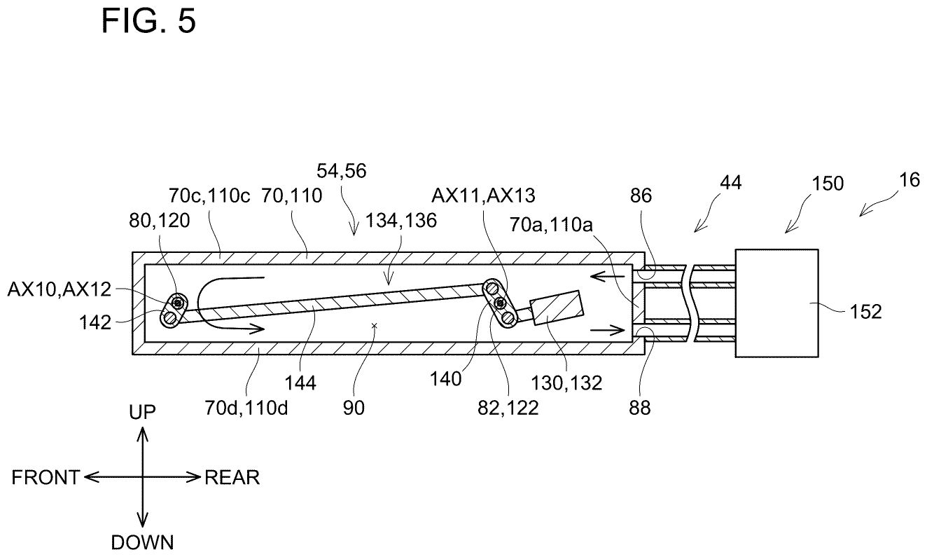

As shown in FIG. 5, the right hand arm 70 is hollow. The right hand arm 70 comprises a first opening 86, a second opening 88, and an internal space 90. The first opening 86 and the second opening 88 are formed in a rear wall 70a of the right hand arm 70. The first opening 86 and the second opening 88 penetrate the rear wall 70a. The first opening 86 and the second opening 88 are spaced apart from each other in the up-down direction. The internal space 90 communicates with the first opening 86 and the second opening 88.

For example, the first right holding member 72 and the second right holding member 74 as shown in FIG. 4 are constituted of ceramics. For example, the ceramics is oxide ceramics or non-oxide ceramics. The first right holding member 72 and the second right holding member 74 are attached to a left wall 70b of the right hand arm 70. The first right holding member 72 and the second right holding member 74 each have a substantially cuboid shape. The first right holding member 72 and the second right holding member 74 are spaced apart from each other in the front-rear direction.

For example, the first right claw 76 is constituted of ceramics. For example, the ceramics is oxide ceramics or non-oxide ceramics. The first right claw 76 is attached to an upper wall 70c of the right hand arm 70. The first right claw 76 projects from the upper wall 70c leftward beyond the left wall 70b. The first right claw 76 is located above the first right holding member 72 and the second right holding member 74.

For example, the second right claw 78 is constituted of ceramics. For example, the ceramics is oxide ceramics or non-oxide ceramics. The second right claw 78 is attached to a lower wall 70d of the right hand arm 70. The second right claw 78 projects from the lower wall 70d leftward beyond the left wall 70b. The second right claw 78 is located below the first right holding member 72 and the second right holding member 74. The first right holding member 72 and the second right holding member 74 are located between the first right claw 76 and the second right claw 78 in the up-down direction. The second right claw 78 is spaced apart from the first right claw 76 in the up-down direction. In the left-right direction, the projecting length of the first right claw 76 from the left wall 70b is shorter than the projecting length of the second right claw 78 from the left wall 70b.

For example, the first right pressing member 80 and the second right pressing member 82 are constituted of ceramics. For example, the ceramics is oxide ceramics or non-oxide ceramics. The first right pressing member 80 and the second right pressing member 82 are attached to the left wall 70b of the right hand arm 70. The first right pressing member 80 is rotatable about a rotation axis AX10 extending in the left-right direction. The first right pressing member 80 rotates between a first position and a second position. The second right pressing member 82 is rotatable about a rotation axis AX11 extending in the left-right direction. The rotation axis AX10 is substantially parallel to the rotation axis AX11. The second right pressing member 82 rotates between a first position and a second position. The first right pressing member 80 is spaced apart from the second right pressing member 82 in the front-rear direction. The first right pressing member 80 is located forward of the second right pressing member 82. In the front-rear direction, the first right holding member 72, the second right holding member 74, the first right claw 76, and the second right claw 78 are located between the first right pressing member 80 and the second right pressing member 82.

The first right pressing member 80 has a substantially L-shape. The first right pressing member 80 comprises a first contact portion 94 and a second contact portion 96. The first contact portion 94 is rotatably attached to the left wall 70b of the right hand arm 70. The second contact portion 96 projects from the lower end of the first contact portion 94 toward the second right pressing member 82. The second contact portion 96 is substantially perpendicular to the first contact portion 94.

The second right pressing member 82 has a substantially L-shape. The second right pressing member 82 comprises a first contact portion 100 and a second contact portion 102. The first contact portion 100 is rotatably attached to the left wall 70b of the right hand arm 70. The second contact portion 102 projects from the lower end of the first contact portion 100 toward the first right pressing member 80. The second contact portion 102 is substantially perpendicular to the first contact portion 100.

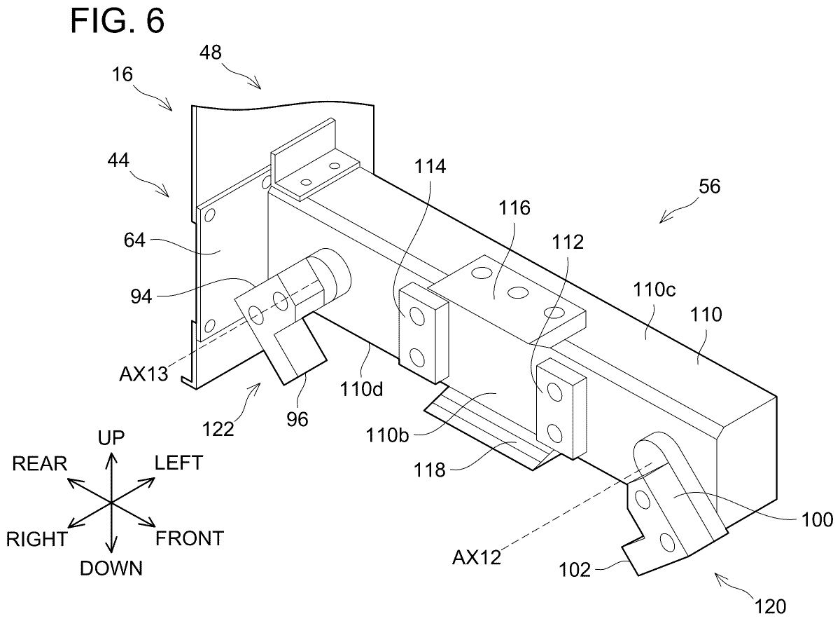

As shown in FIG. 6, the left hand arm unit 56 comprises a left hand arm 110, a first left holding member 112, a second left holding member 114, a first left claw 116, a second left claw 118, a first left pressing member 120, and a second left pressing member 122. The left hand arm 110, the first left holding member 112, the second left holding member 114, the first left claw 116, the second left claw 118, the first left pressing member 120, and the second left pressing member 122 are spaced apart in the left-right direction from the right hand arm 70, the first right holding member 72, the second right holding member 74, the first right claw 76, the second right claw 78, the first right pressing member 80, and the second right pressing member 82, respectively. The left hand arm 110, the first left holding member 112, the second left holding member 114, the first left claw 116, the second left claw 118, the first left pressing member 120, and the second left pressing member 122 are in a plane-symmetrical relationship with the right hand arm 70, the first right holding member 72, the second right holding member 74, the first right claw 76, the second right claw 78, the first right pressing member 80, and the second right pressing member 82 with respect to the imaginary plane P1 (see FIG. 3), respectively. The shape and material of the left hand arm 110 are the same as those of the right hand arm 70. The materials of the first left holding member 112, the second left holding member 114, the first left claw 116, the second left claw 118, the first left pressing member 120, and the second left pressing member 122 are the same as those of the first right holding member 72, the second right holding member 74, the first right claw 76, the second right claw 78, the first right pressing member 80, and the second right pressing member 82, respectively.

The left hand arm 110 is movable in the left-right direction relative to the arm support 64. The left hand arm 110 is moved by the controller 18 (see FIG. 2) controlling the arm actuator (not shown). The configuration of the left hand arm 110 is substantially the same as that of the right hand arm 70. Thus, as shown in FIG. 5, the left hand arm 110 also comprises a first opening 86, a second opening 88, and an internal space 90. The first opening 86 and the second opening 88 penetrate a rear wall 110a of the left hand arm 110.

As shown in FIG. 6, the first left holding member 112 and the second left holding member 114 are attached to a right wall 110b of the left hand arm 110. The right wall 110b of the left hand arm 110 faces the left wall 70b of the right hand arm 70. The configuration of the first left holding member 112 is substantially the same as that of the first right holding member 72, and the configuration of the second left holding member 114 is substantially the same as that of the second right holding member 74.

The first left claw 116 projects rightward from an upper wall 110c of the left hand arm 110 toward the first right claw 76 beyond the right wall 110b. The second left claw 118 projects rightward from a lower wall 110d of the left hand arm 110 toward the second right claw 78 beyond the right wall 110b. In the left-right direction, the projecting length of the first left claw 116 from the right wall 110b is shorter than the projecting length of the second left claw 118 from the right wall 110b.

The first left pressing member 120 and the second left pressing member 122 are attached to the right wall 110b of the left hand arm 110. The configuration of the first left pressing member 120 is substantially the same as that of the second right pressing member 82. Thus, the first left pressing member 120 comprises a first contact portion 100 and a second contact portion 102. The first left pressing member 120 is rotatable about a rotation axis AX12 extending in the left-right direction. The first left pressing member 120 rotates between a first position and a second position. The configuration of the second left pressing member 122 is substantially the same as that of the first right pressing member 80. Thus, the second left pressing member 122 comprises a first contact portion 94 and a second contact portion 96. The second left pressing member 122 is rotatable about a rotation axis AX13 extending in the left-right direction. The second left pressing member 122 rotates between a first position and a second position.

As shown in FIG. 5, the robot hand 44 further comprises actuators 130, 132 and link units 134, 136. The actuators 130, 132 are simultaneously controlled by the controller 18 (see FIG. 2). The actuator 130 and the link unit 134 are located in the internal space 90 of the right hand arm 70. The link unit 134 connects the first right pressing member 80 and the second right pressing member 82 to each other. The link unit 134 is actuated by the actuator 130. The link unit 134 rotates the first right pressing member 80 and the second right pressing member 82 simultaneously. The actuator 132 and the link unit 136 are located in the internal space 90 of the left hand arm 110. The link unit 136 connects the first left pressing member 120 and the second left pressing member 122 to each other. The link unit 136 is actuated by the actuator 132. The link unit 136 rotates the first left pressing member 120 and the second left pressing member 122 simultaneously. The configuration of the actuator 130 is substantially the same as that of the actuator 132, and the configuration of the link unit 134 is substantially the same as that of the link unit 136. Therefore, only the actuator 130 and the link unit 134 will be described in detail below as an example, and detailed description for the actuator 132 and the link unit 136 is omitted.

The actuator 130 is located closer to the first opening 86 and the second opening 88 than the link unit 134 is. For example, the actuator 130 comprises a cylinder and a piston rod moved back and forth by the cylinder.

The link unit 134 comprises a first member 140, a second member 142, and a connection member 144. The first member 140, the second member 142, and the connection member 144 each have an elongated plate shape.

One end of the first member 140 is rotatably attached to an actuator end of the actuator 130. A central portion of the first member 140 is directly or indirectly attached to the second right pressing member 82 and they are thus integral with each other. The first member 140 is rotatable about the rotation axis AX11. When the first member 140 rotates, the second right pressing member 82 rotates together.

One end of the second member 142 is directly or indirectly attached to the first right pressing member 80 and they are thus integral with each other. The second member 142 is rotatable about the rotation axis AX10. When the second member 142 rotates, the first right pressing member 80 rotates together.

The connection member 144 is rotatably attached to the other end of the first member 140 and the other end of the second member 142.

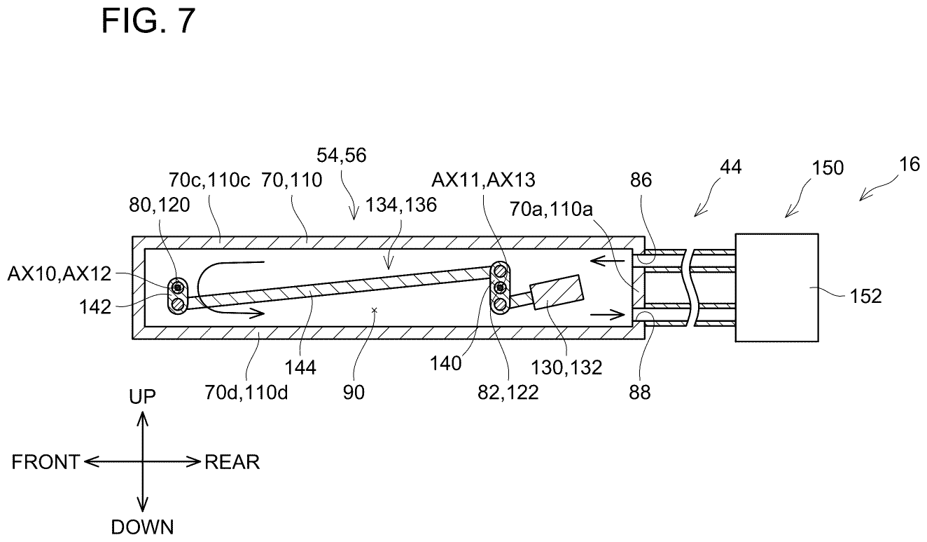

As shown in FIGS. 5 and 7, when the actuator 130 operates, the one end of the first member 140 is moved by the actuator 130. In response, the first member 140 rotates about the rotation axis AX11. As the first member 140 rotates, one end of the connection member 144 is moved, and in response to this movement, the other end of the connection member 144 moves the one end of the second member 142, resulting in the rotation of the second member 142 about the rotation axis AX10. Thus, the first right pressing member 80 rotates from the first position to the second position, and at the same time, the second right pressing member 82 rotates from the first position to the second position, or the first right pressing member 80 rotates from the second position to the first position, and at the same time, the second right pressing member 82 rotates from the second position to the first position.

The robot hand 44 further comprises cooling mechanisms 150. The cooling mechanisms 150 are located on the right hand arm 70 and the left hand arm 110, respectively. Each cooling mechanism 150 comprises a supply device 152.

The supply devices 152 are configured to supply fluid (coolant) to the right hand arm 70 and the left hand arm 110 according to control by the controller 18 (see FIG. 2). For example, the fluid is a cooling gas or compressed air. In a variant, the fluid may be liquid such as water or the like. The supply devices 152 are attached to the first opening 86 and the second opening 88 of the right hand arm 70 and the first opening 86 and the second opening 88 of the left hand arm 110, respectively. The supply devices 152 supply the fluid into the internal spaces 90 through the first opening 86 of the right hand arm 70 and the first opening 86 of the left hand arm 110. The right hand arm 70 and the left hand arm 110 are cooled by the fluid flowing through the internal spaces 90. In FIGS. 5 and 7, arrows indicate the flowing direction of the fluid. After flowing through the internal spaces 90, the fluid is discharged from the internal spaces 90 through the second opening 88 of the right hand arm 70 and the second opening 88 of the left hand arm 110. Flow paths for the fluid may be formed in the internal spaces 90, and the flow paths may control the flow of the fluid in the internal spaces 90. This prevents the fluid from flowing by shortcut from the first openings 86 to the second openings 88, allowing for efficient cooling of the entire hand arms 70, 110. The flow paths for the fluid may be formed from pipes in the internal spaces 90. In this case, each pipe may have a plurality of holes and the fluid may be ejected to the outside of the pipe from the plurality of holes.

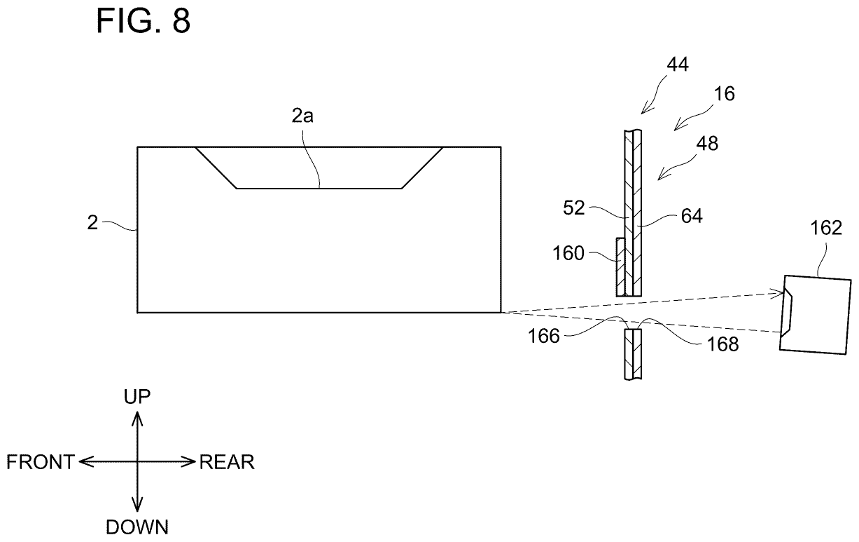

As shown in FIG. 8, the robot hand 44 further comprises a shutter 160 and a saggar detection sensor 162.

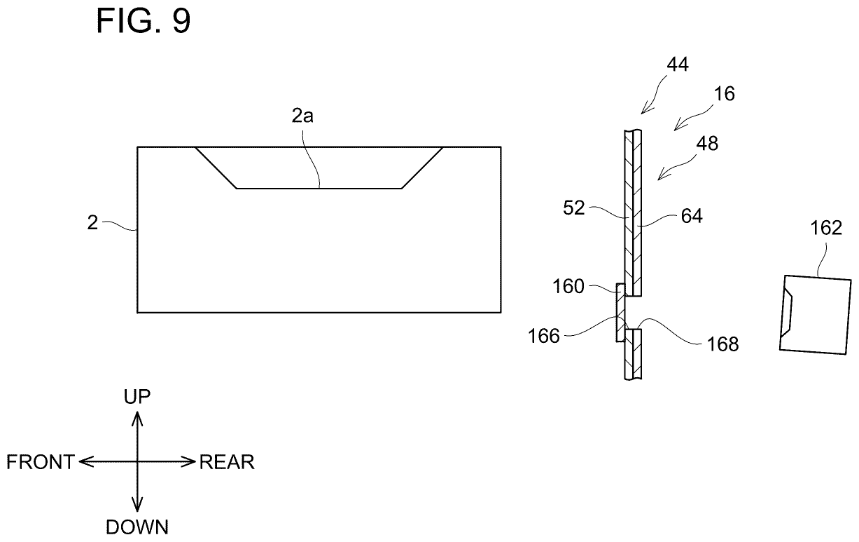

The shutter 160 is movably attached to the heat shielding member 52. The shutter 160 moves between an open position and a closed position according to control by the controller 18 (see FIG. 2). When the shutter 160 is at the open position, the shutter 160 opens an opening 166 in the heat shielding member 52 and an opening 168 in the arm support 64. As shown in FIG. 9, when the shutter 160 is at the closed position, the shutter 160 closes the opening 166 in the heat shielding member 52 and the opening 168 in the arm support 64.

The saggar detection sensor 162 is located inside the arm support 64. The saggar detection sensor 162 detects whether a saggar 2 is positioned at a predetermined position. For example, the saggar detection sensor 162 is a laser sensor. As shown in FIG. 8, when the shutter 160 is at the open position, the saggar detector sensor 162 emits laser toward the opening 166 of the heat shielding member 52 and the opening 168 of the arm support 64 according to control by the controller 18 (see FIG. 2). When the saggar detector sensor 162 receives the laser within a predetermined time period from the time at which the laser was emitted, it can be said that the saggar 2 is positioned at the predetermined position.

As shown in FIGS. 10 to 17, under the control by the controller 18 (see FIG. 2), the robot 16 holds a saggar 2 conveyed out from the heat treatment furnace 12 (see FIG. 1), moves the saggar 2 such that the material 4 therein is recovered, and places the saggar 2 on the bedplate 8. The robot 16 performs the following steps in sequence: a preparation step, a first holding step, a lifting step, a positioning step, a second holding step, a first moving step, a first inverting step, a second inverting step, a second moving step, a positioning releasing step, a lowering step, and a hold releasing step.

As shown in FIG. 10, in the preparation step, the robot arm 42 (see FIG. 2) operates based on the position and orientation of a saggar 2 detected by the saggar detector 36 (see FIG. 2) to move the robot hand 44 such that the saggar 2 is placed between the right hand arm 70 and the left hand arm 110. Then, as shown in FIG. 8, the shutter 160 moves from the closed position to the open position and the saggar detection sensor 162 emits laser. When the controller 18 (see FIG. 2) detects that the saggar detection sensor 162 received the laser within the predetermined time period, the shutter 160 moves from the open position to the closed position. This suppresses the heat of the saggar 2 from transferring to the saggar detection sensor 162 compared to a configuration in which the shutter 160 is always at the open position. After this, the first holding step is performed.

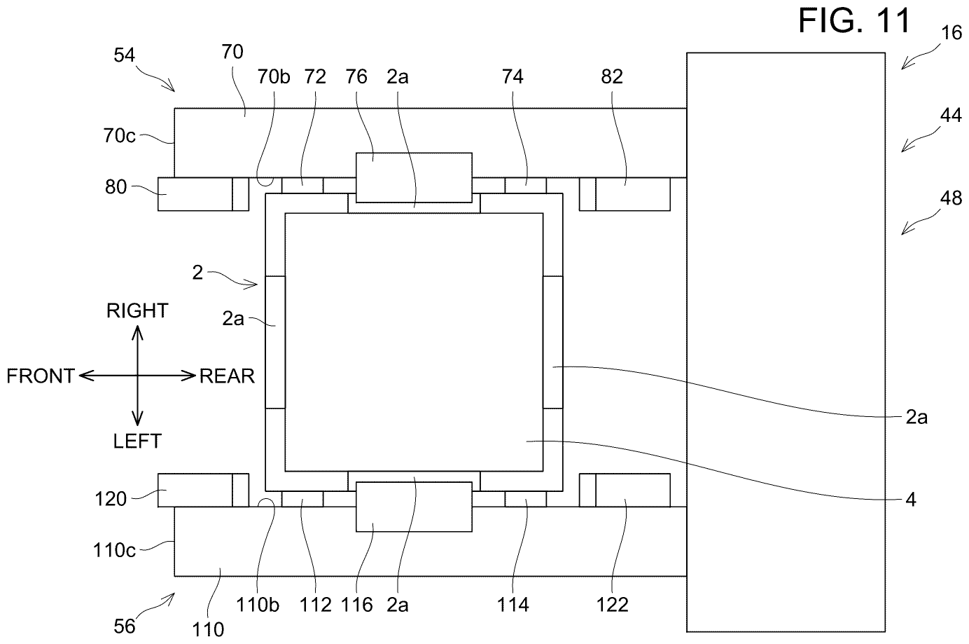

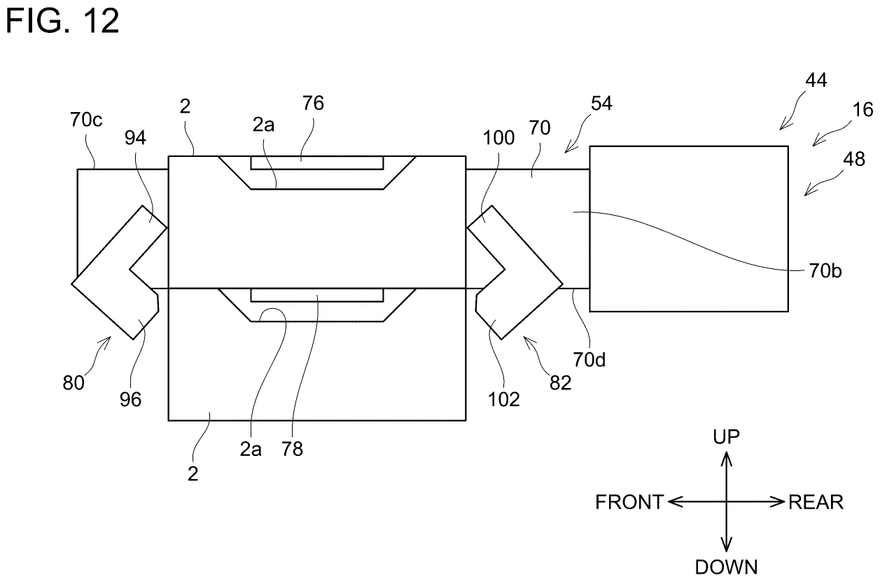

As shown in FIGS. 11 and 12, in the first holding step, the right hand arm 70 and the left hand arm 110 move toward each other. Consequently, the saggar 2 is pinched between the first right holding member 72 and the first left holding member 112 and between the second right holding member 74 and the second left holding member 114. The saggar 2 is held with a first holding force by the first right holding member 72, the second right holding member 74, the first left holding member 112, and the second left holding member 114. At this time, the saggar 2 is in contact with the first right holding member 72, the second right holding member 74, the first left holding member 112, and the second left holding member 114, but is not in contact with the right hand arm 70 nor the left hand arm 110. The clearances between the saggar 2 and the right hand arm 70 and between the saggar 2 and the left hand arm 110 suppress the heat of the saggar 2 from transferring to the right hand arm 70 and the left hand arm 110 compared to a configuration in which the saggar 2 is in contact with the right hand arm 70 and the left hand arm 110. Further, since the fluid is flowing through the internal spaces 90 of the right hand arm 70 and the left hand arm 110 as shown in FIG. 5, the right hand arm 70 and the left hand arm 110 are suppressed from having high temperatures. Thus, a malfunction of the hand arm units 54, 56, i.e., a malfunction of the robot hand 44 is prevented. Further, since the first openings 86 and the second openings 88 are formed in the rear walls 70a, 110a, interference between the supply devices 152 and the saggar 2 is prevented.

As shown in FIGS. 11 and 12, the movement of the right hand arm 70 and the left hand arm 110 causes insertion of the first right claw 76 and the first left claw 116 into notches 2a of the saggar 2 being held (hereinafter, the saggar 2 being held will be termed “target saggar 2”). Thus, the first right claw 76 and the first left claw 116 are placed on the upper side of the target saggar 2. Also, the second right claw 78 and the second left claw 118 (see FIG. 6) are inserted in notches 2a of a saggar 2 located immediately below the target saggar 2. Thus, the second right claw 78 and the second left claw 118 are placed on the lower side of the target saggar 2 (i.e., they are placed on the side of the target saggar 2 where the first right claw 76 and the first left claw 116 are not placed). In this state, the target saggar 2 is placed between the first right claw 76 and the second right claw 78 and between the first left claw 116 and the second left claw 118. If the target saggar 2 is on spacers 6 (see FIG. 2), the second right claw 78 and the second left claw 118 are inserted between the target saggar 2 and the bedplate 8 (see FIG. 2). As such, in the first holding step, the step of holding the saggar 2 by the first right holding member 72, the second right holding member 74, the first left holding member 112, and the second left holding member 114, the step of placing the first right claw 76 and the first left claw 116 on the upper side of the target saggar 2, and the step of placing the second right claw 78 and the second left claw 118 on the lower side of the target saggar 2 are performed simultaneously.

After the right hand arm 70 and the left hand arm 110 have moved toward each other, the shutter 160 moves from the closed position to the open position as shown in FIG. 8 and the saggar detection sensor 162 emits laser. When the controller 18 (see FIG. 2) detects that the saggar detection sensor 162 received the laser within the predetermined time period, the shutter 160 moves from the open position to the closed position. After this, the lifting step is performed.

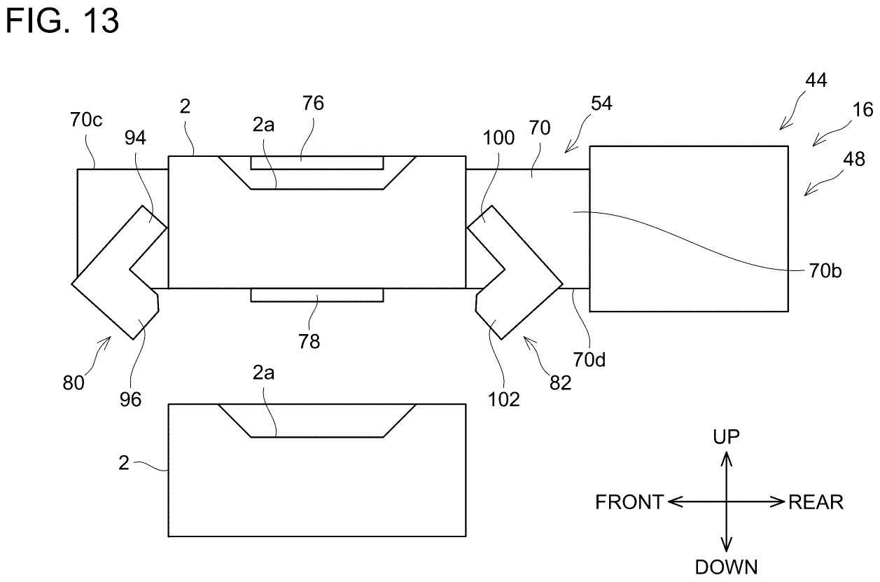

As shown in FIG. 13, in the lifting step, the robot arm 42 (see FIG. 2) operates to move the robot hand 44 upward. The target saggar 2 is thereby lifted by the robot hand 44 and separated from saggars 2 on the bedplate 8. If the target saggar 2 is on spacers 6, the target saggar 2 is separated from the spacers 6. When lifted by the robot arm 42, the target saggar 2 is on the second right claw 78 and the second left claw 118. In this state, there are clearances (second clearances) between the target saggar 2 and the first right claw 76 and between the target saggar 2 and the first left claw 116.

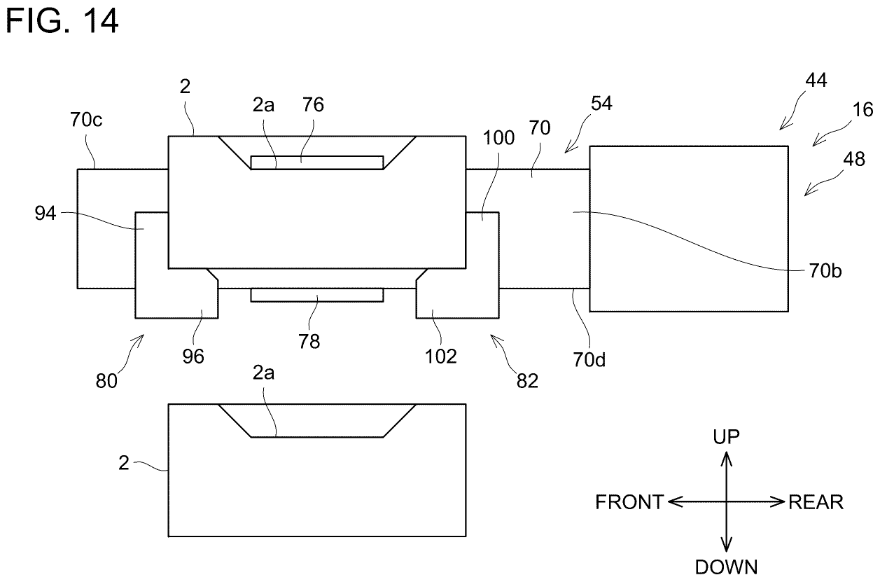

As shown in FIG. 7, in the positioning step following the lifting step, the actuators 130, 132 simultaneously operate so that the link unit 134 moves the first right pressing member 80 and the second right pressing member 82 simultaneously and the link unit 136 moves the first left pressing member 120 and the second left pressing member 122 simultaneously. Thus, as shown in FIG. 14, the first right pressing member 80, the second right pressing member 82, the first left pressing member 120 (see FIG. 6), and the second left pressing member 122 (see FIG. 6) simultaneously rotate from their second positions where they do not contact the saggar 2 to their first positions where they contact the saggar 2. Consequently, the second contact portion 96 of the first right pressing member 80, the second contact portion 102 of the second right pressing member 82, the second contact portion 102 of the first left pressing member 120, and the second contact portion 96 of the second left pressing member 122 contact the lower surface of the target saggar 2 in the up-down direction and press the target saggar 2 against the first right claw 76 and the first left claw 116 (see FIG. 6). Thus, the target saggar 2 is moved upward relative to the first right holding member 72, the second right holding member 74, the first left holding member 112, and the second left holding member 114 and separated from the second right claw 78 and the second left claw 118 (see FIG. 6). Clearances (first clearances) are thereby formed between the target saggar 2 and the second right claw 78 and between the target saggar 2 and the second left claw 118. Further, as a result of the rotation of the first right pressing member 80, the second right pressing member 82, the first left pressing member 120, and the second left pressing member 122, the first contact portion 94 of the first right pressing member 80, the first contact portion 100 of the second right pressing member 82, the first contact portion 100 of the first left pressing member 120, and the first contact portion 94 of the second left pressing member 122 contact the target saggar 2 in the front-rear direction. The target saggar 2 is thus pinched between the first contact portion 94 of the first right pressing member 80 and the first contact portion 100 of the second right pressing member 82 and between the first contact portion 100 of the first left pressing member 120 and the first contact portion 94 of the second left pressing member 122. Thus, the target saggar 2 is positioned relative to the robot hand 44 in the front-rear direction and in the up-down direction. As such, in the positioning step, the step of positioning the target saggar 2 in the front-rear direction relative to the robot hand 44 and the step of positioning the target saggar 2 in the up-down direction relative to the robot hand 44 are simultaneously performed. The positioning step prevents the target saggar 2 from falling off from the robot hand 44. Further, the positioning step allows for a reduction in time required to position the target saggar 2 compared to a configuration in which the step of positioning the target saggar 2 in the front-rear direction relative to the robot hand 44 and the step of positioning the target saggar 2 in the up-down direction relative to the robot hand 44 are performed at different times. Moreover, the target saggar 2 is suppressed from wobbling in the front-rear direction and in the up-down direction. Further, the movement of the target saggar 2 is suppressed in the up-down direction and in the front-rear direction while the robot hand 44 is moving. This suppresses displacement of the target saggar 2 in the up-down direction and in the front-rear direction relative to the robot hand 44.

As shown in FIG. 11, in the second holding step following the positioning step, the right hand arm 70 and the left hand arm 110 slightly move toward each other. The target saggar 2 is thereby held with a second holding force that is greater than the first holding force with which the target saggar 2 is held in the first holding step. Since the target saggar 2 is held with the second holing force in the left-right direction relative to the robot hand 44, the wobbling of the target saggar 2 in the left-right direction is suppressed. Further, the target saggar 2 is further suppressed from moving in the front-rear direction and in the up-down direction while the robot hand 44 is moving. Thus, the displacement of the target saggar 2 in the front-rear direction and in the up-down direction relative to the robot hand 44 is further suppressed. In this embodiment, contact members that contact a saggar 2 (e.g., the holding members 72, 74, the right claws 76, 78, and the pressing members 80, 82) are constituted of ceramics. This allows the robot hand 44 to hold a high-temperature saggar 2 conveyed out from the heat treatment furnace 12. If the contact members are formed of ceramics-coated metal members, the ceramics may separate from the metal members, however, such separation will not occur in the contact members in this embodiment. Thus, a decrease in the heat resistance and corrosion resistance of the contact members is suppressed.

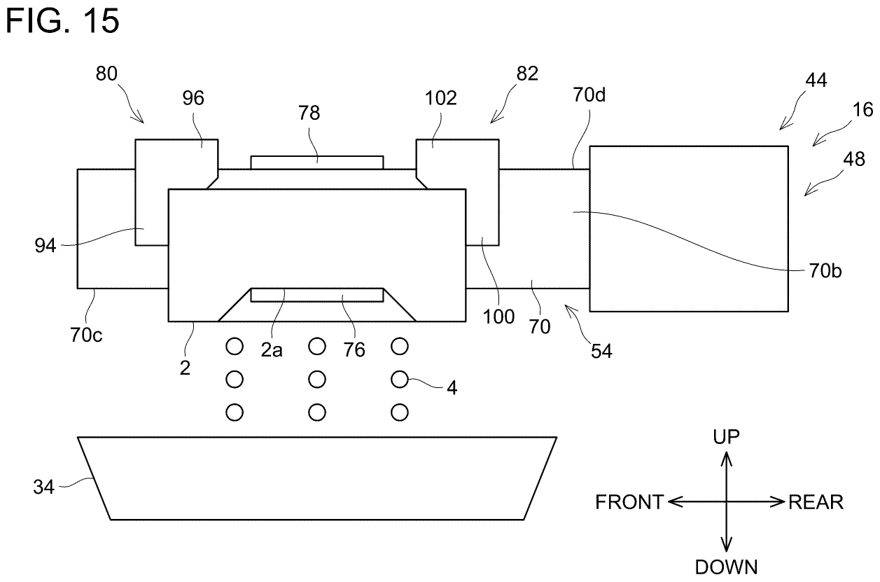

As shown in FIG. 15, in the first moving step following the second holding step, the robot arm 42 (see FIG. 2) operates to move the robot hand 44 such that the target saggar 2 is moved to the recovery container 34. Then, as shown in FIG. 8, the shutter 160 moves from the closed position to the open position and the saggar detection sensor 162 emits laser. When the controller 18 (see FIG. 2) detects that the saggar detection sensor 162 received the laser within the predetermined time period, the shutter 160 moves from the open position to the closed position. After this, the first inverting step is performed.

As shown in FIG. 15, in the first inverting step, the robot arm 42 (see FIG. 2) operates to rotate the robot hand 44 180 degrees about the axis AX6 (see FIG. 2), and the target saggar 2 is thereby inverted above the recovery container 34. Since the opening of the target saggar 2 is directed downward, the material 4 in the target saggar 2 is recovered into the recovery container 34. Further, since the projecting length of the first right claw 76 from the left wall 70b in the left-right direction is shorter than the projecting length of the second right claw 78 from the left wall 70b in the left-right direction and the projecting length of the first left claw 116 from the right wall 110b in the left-right direction is shorter than the projecting length of the second left claw 118 from the right wall 110b in the left-right direction, the material 4 is suppressed from accumulating on the first right claw 76 and the first left claw 116.

In the second inverting step following the first inverting step, the robot arm 42 (see FIG. 2) operates to rotate the robot hand 44 180 degrees about the axis AX6 (see FIG. 2), and the target saggar 2 is thereby inverted above the recovery container 34. Consequently, the opening of the target saggar 2 is directed upward. The rotation direction of the robot hand 44 in the second inverting step is opposite to the rotation direction of the robot hand 44 in the first inverting step. Then, as shown in FIG. 8, the shutter 160 moves from the closed position to the open position and the saggar detection sensor 162 emits laser. When the controller 18 (see FIG. 2) detects that the saggar detection sensor 162 received the laser within the predetermined time period, the shutter 160 moves from the open position to the closed position. After this, the second moving step is performed.

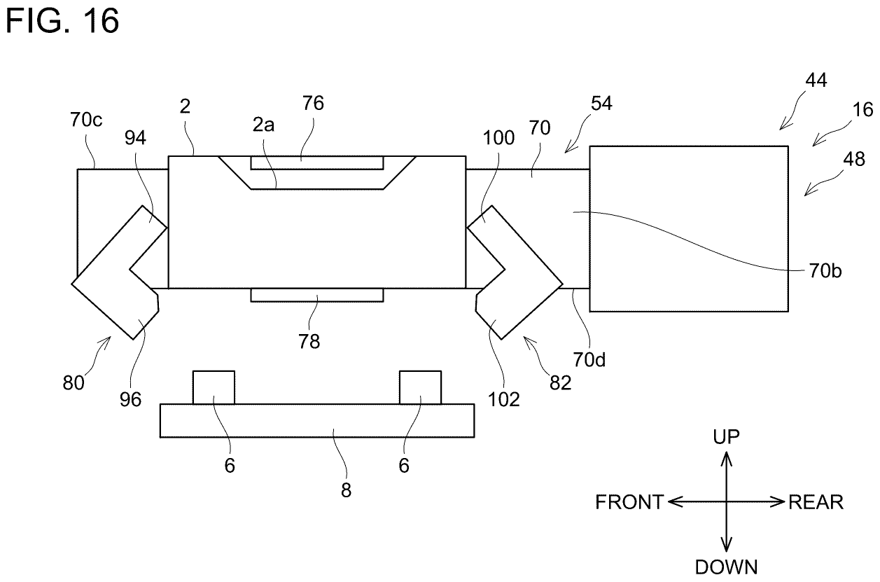

As shown in FIG. 16, in the second moving step, the robot arm 42 (see FIG. 2) operates to move the robot hand 44 such that the target saggar 2 is moved to a position over the bedplate 8. The movement of the robot hand 44 may move the target saggar 2 to a position other than the position over the bedplate 8. For example, the movement of the robot hand 44 may move the target saggar 2 to a lifter located at one end of a conveyor that conveys saggars 2 to the entrance 20.

In the positioning releasing step following the second moving step, the right hand arm 70 and the left hand arm 110 slightly move away from each other. Consequently, the target saggar 2 is held with the first holding force by the first right holding member 72, the second right holding member 74, the first left holding member 112, and the second left holding member 114. Thus, the target saggar 2 is released from being positioned in the left-right direction relative to the robot hand 44. Then, as shown in FIG. 5, the actuators 130, 132 operate simultaneously so that the link unit 134 moves the first right pressing member 80 and the second right pressing member 82 simultaneously and the link unit 136 moves the first left pressing member 120 and the second left pressing member 122 simultaneously. Thereby, as shown in FIG. 16, the first right pressing member 80, the second right pressing member 82, the first left pressing member 120 (see FIG. 6), and the second left pressing member 122 (see FIG. 6) simultaneously rotate from the first positions to the second positions. This removes the force with which the target saggar 2 has been pressed against the first right claw 76 and the first left claw 116 by the first right pressing member 80, the second right pressing member 82, the first left pressing member 120, and the second left pressing member 122. The target saggar 2 is held with the first holding force by the holding members 72, 74, 112, and 114. By setting the first holding force to a force smaller than the own weight of the target saggar 2, the target saggar 2 can move downward by its own weight. Consequently, the target saggar 2 separates from the first right claw 76 and the first left claw 116 and sits on the second right claw 78 and the second left claw 118 (see FIG. 6). Thus, the target saggar 2 is released from being positioned in the front-rear direction and in the up-down direction relative to the robot hand 44. If the first holding force is set to a force larger than the own weight of the target saggar 2, the target saggar 2 does not separate from the first right claw 76 and the first left claw 116 and remains its contact with the first right claw 76 and the first left claw 116.

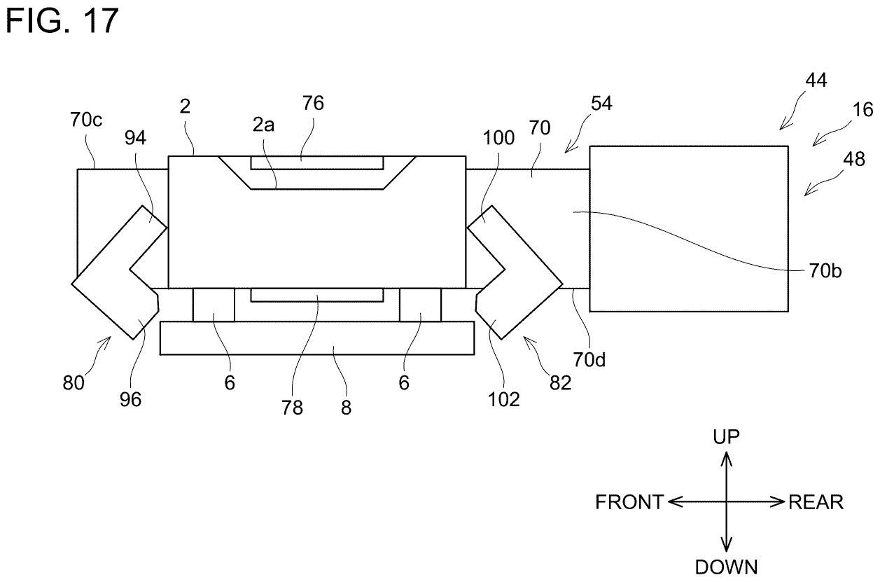

As shown in FIG. 17, in the lowering step following the positioning releasing step, the robot arm 42 (see FIG. 2) operates to move the robot hand 44 downward. The target saggar 2 is thereby lowered and placed on spacers 6 on the bedplate 8.

In the hold releasing step following the lowering step, the right hand arm 70 and the left hand arm 110 move further away from each other. Consequently, the target saggar 2 separates from the first right holding member 72, the second right holding member 74, the first left holding member 112, and the second left holding member 114. Thus, the target saggar 2 is released from being held by the first right holding member 72, the second right holding member 74, the first left holding member 112, and the second left holding member 114. Further, the first right claw 76 and the first left claw 116 (see FIG. 6) are removed from the notches 2a of the target saggar 2, and the second right claw 78 and the second left claw 118 (see FIG. 6) are also removed from between the target saggar 2 and the bedplate 8.

### Advantageous Effects

In the above embodiment, the supply devices 152 supply the fluid to the internal spaces 90 of the right hand arm unit 54 and the left hand arm unit 56. The right hand arm unit 54 and the left hand arm unit 56 are cooled by the fluid flowing through the internal spaces 90. This prevents the right hand arm unit 54 and the left hand arm unit 56 from reaching high temperatures even when they hold a high-temperature saggar 2. Thus, occurrence of malfunction of the robot hand 44 is prevented.

### Correspondence Relationships

The right hand arm unit 54 and the left hand arm unit 56 are examples of “hand arm unit”. The first right holding member 72, the second right holding member 74, the first left holding member 112, and the second left holding member 114 are examples of “contact member”. The rear walls 70a, 110a are examples of “second wall”. The left wall 70b and the right wall 110b are examples of “first wall”.

### Second Embodiment

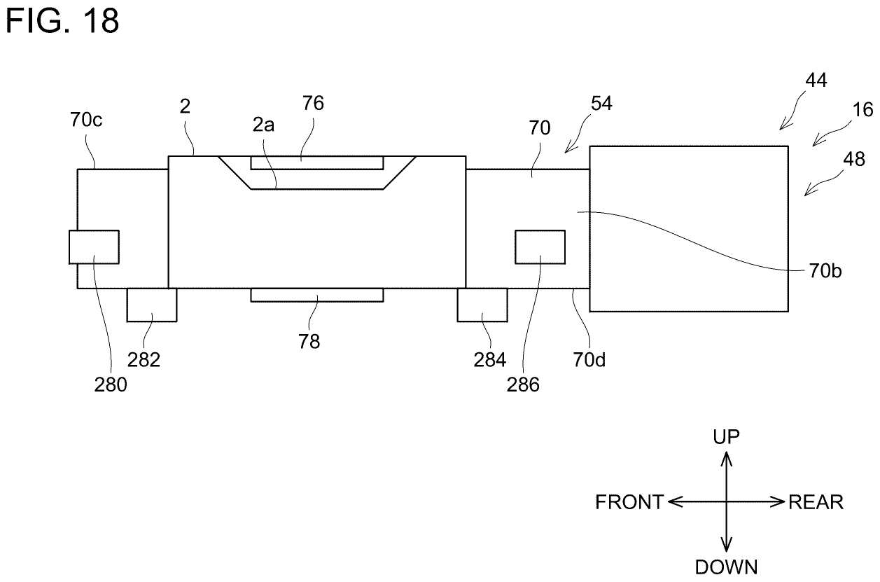

For a second embodiment, differences from the first embodiment are described. As shown in FIG. 18, in the second embodiment, the right hand arm unit 54 comprises a first right pressing member 280, a second right pressing member 282, a third right pressing member 284, and a fourth right pressing member 286, instead of the first right pressing member 80 and the second right pressing member 82 in the first embodiment.

The first right pressing member 280, the second right pressing member 282, the third right pressing member 284, and the fourth right pressing member 286 are attached to the left wall 70b of the right hand arm 70. The first right pressing member 280 and the second right pressing member 282 are located forward of the first right holding member 72 (see FIG. 4), the second right holding member 74 (see FIG. 4), the first right claw 76, and the second right claw 78. The third right pressing member 284 and the fourth right pressing member 286 are located rearward of the first right holding member 72, the second right holding member 74, the first right claw 76, and the second right claw 78. In the front-rear direction, the third right pressing member 284 and the fourth right pressing member 286 are located between the first right pressing member 280 and the second right pressing member 282. The first right pressing member 280 and the fourth right pressing member 286 are movable in the front-rear direction. The second right pressing member 282 and the third right pressing member 284 are movable in the up-down direction.

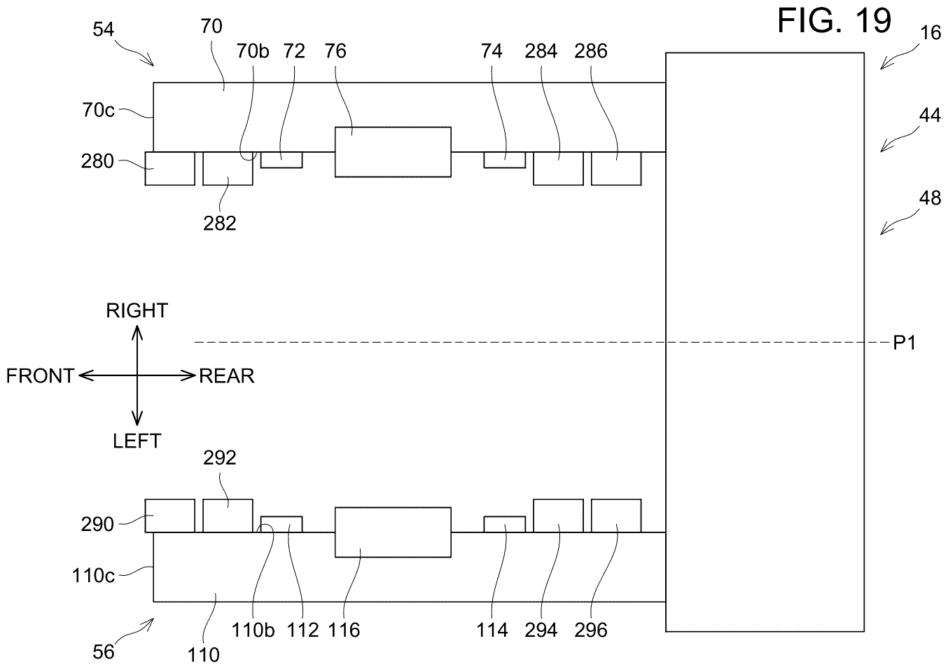

As shown in FIG. 19, the left hand arm unit 56 comprises a first left pressing member 290, a second left pressing member 292, a third left pressing member 294, and a fourth left pressing member 296, instead of the first left pressing member 120 and the second left pressing member 122 in the first embodiment. The first left pressing member 290, the second left pressing member 292, the third left pressing member 294, and the fourth left pressing member 296 are in a plane-symmetrical relationship with the first right pressing member 280, the second right pressing member 282, the third right pressing member 284, and the fourth right pressing member 286 with respect to the imaginary plane P1, respectively. The first left pressing member 290, the second left pressing member 292, the third left pressing member 294, and the fourth left pressing member 296 are attached to the right wall 110b of the left hand arm 110. The first left pressing member 290 and the fourth left pressing member 296 are movable in the front-rear direction. The second left pressing member 292 and the third left pressing member 294 are movable in the up-down direction.

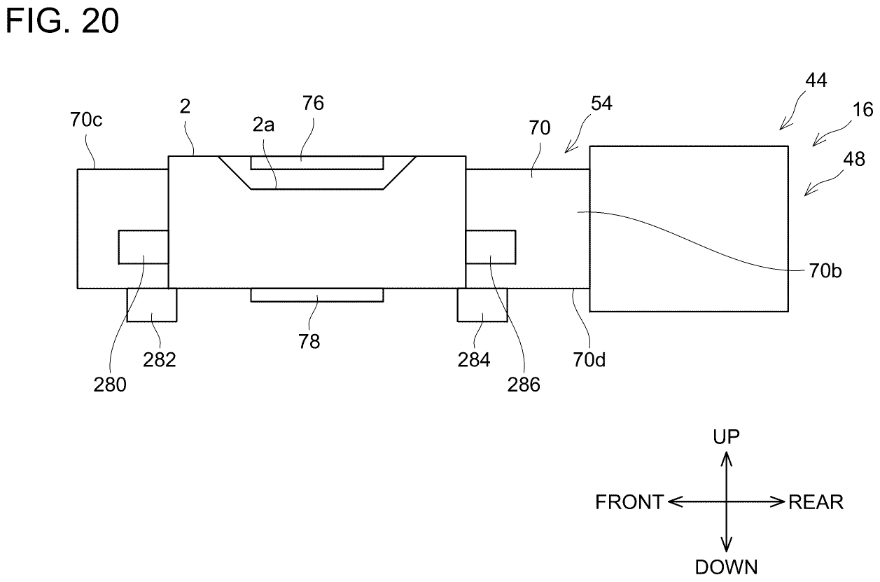

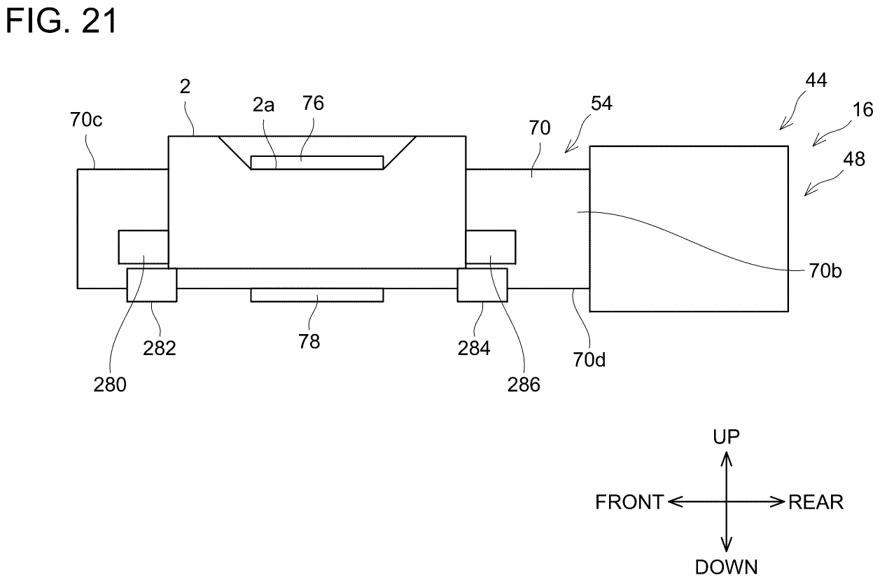

As shown in FIG. 20, in a positioning step according to the second embodiment, the first right pressing member 280 and the fourth right pressing member 286 move toward each other, and at the same time, the first left pressing member 290 (see FIG. 19) and the fourth left pressing member 296 (see FIG. 19) also move toward each other. Consequently, a saggar 2 is pinched between the first right pressing member 280 and the fourth right pressing member 286 and between the first left pressing member 290 and the fourth left pressing member 296. Thus, the saggar 2 is positioned in the front-rear direction relative to the robot hand 44. Then, as shown in FIG. 21, the second right pressing member 282, the third right pressing member 284, the second left pressing member 292 (see FIG. 19), and the third left pressing member 294 (see FIG. 19) simultaneously move upward. Consequently, the saggar 2 is pressed against the first right claw 76 and the first left claw 116 (see FIG. 19) by the second right pressing member 282, the third right pressing member 284, the second left pressing member 292, and the third left pressing member 294. Thus, the saggar 2 is positioned in the up-down direction relative to the robot hand 44.

As shown in FIG. 18, in a positioning releasing step according to the second embodiment, the second right pressing member 282, the third right pressing member 284, the second left pressing member 292, and the third left pressing member 294 simultaneously move downward. Consequently, the saggar 2 is placed on the second right claw 78 and the second left claw 118 (see FIG. 6). Further, the first right pressing member 280 and the fourth right pressing member 286 move away from each other, and at the same time, the first left pressing member 290 and the fourth left pressing member 296 also move away from each other. Consequently, the saggar 2 separates from the first right pressing member 280, the fourth right pressing member 286, the first left pressing member 290, and the fourth left pressing member 296. Thus, the saggar 2 is released from being positioned in the front-rear direction and in the up-down direction relative to the robot hand 44.

### Variants

In an embodiment, the conveyor device 14 may comprise a plurality of rollers instead of the guide member 28 and the pusher 30. In this case, each roller of the plurality of rollers is rotatably supported at its opposing ends by the heat treatment furnace 12. The rotation of the rollers conveys the bedplate 8 on the rollers. Further, multiple saggars 2 may be stacked on top of each other and the stack of saggars 2 may be placed on the bedplate 8, or only a single saggar 2 may be placed on the bedplate 8. Moreover, saggars 2 may be directly placed on the rollers without the use of the bedplate 8. In this case, the heat treatment system 10 may comprise a lift device configured to separate a saggar 2 from the rollers. The robot hand 44 holds the saggar 2 after the saggar 2 has been separated from the rollers by the lift device (i.e., after a space has been formed between the saggar 2 and the rollers).

In an embodiment, the right hand arm unit 54 may comprise only one of the first right holding member 72 and the second right holding member 74 or may comprise one or more holding members in addition to the first right holding member 72 and the second right holding member 74. The left hand arm unit 56 may comprise only one of the first left holding member 112 and the second left holding member 114 or may comprise one or more holding members in addition to the first left holding member 112 and the second left holding member 114.

In an embodiment, in the positioning step, the first right pressing member 80, the second right pressing member 82, the first left pressing member 120, and the second left pressing member 122 may press a saggar 2 against the second right claw 78 and the second left claw 118. In this case, the saggar 2 is pressed downward.

In an embodiment, in the positioning step, the step of positioning a saggar 2 in the front-rear direction relative to the robot hand 44 may not be performed.

In an embodiment, the first opening 86 and the second opening 88 may be formed in a wall other than the rear wall 70a of the right hand arm 70 (or a wall other than the rear wall 110a of the left hand arm 110). Further, the first opening 86 and the second opening 88 may be spaced apart from each other in the left-right direction or in the front-rear direction. Moreover, a wall of the right hand arm 70 (or a wall of the left hand arm 110) in which the first opening 86 is formed may be different from a wall of the right hand arm 70 (or a wall of the left hand arm 110) in which the second opening 88 is formed. For example, the first opening 86 may be formed in the rear wall 70a of the right hand arm 70 (or the rear wall 110a of the left hand arm 110), while the second opening 88 may be formed in the front wall of the right hand arm 70 (or the front wall of the left hand arm 110). This prevents the fluid from flowing by shortcut from the first opening 86 to the second opening 88.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A robot hand comprising:
a hand arm unit for holding a saggar conveyed out from a heat treatment furnace; and
a cooling mechanism for cooling the hand arm unit.

2. The robot hand according to claim 1, wherein the cooling mechanism is located in the hand arm unit.

3. The robot hand according to claim 1, wherein
the hand arm unit comprises a hand arm including a first opening, a second opening, and an internal space, and
the cooling mechanism comprises a supply device that is attached to the first opening, supplies a fluid to the internal space through the first opening, and discharges the fluid from the internal space through the second opening.

4. The robot hand according to claim 3, wherein
the hand arm unit further comprises a contact member configured to contact the saggar when the hand arm unit holds the saggar, and
the hand arm comprises:
a first wall to which the contact member is attached; and
a second wall in which the first opening is formed, the second wall being different from the first wall.

5. The robot hand according to claim 4, wherein
the supply device is attached to the second opening, and
the second opening is formed in the second wall.

6. The robot hand according to claim 3, wherein the fluid is a cooling gas or compressed air.

7. The robot hand according to claim 1, further comprising:
a base supporting the hand arm unit; and
an attachment member configured to attach the base to a robot arm,
wherein a thermal conductivity of the attachment member is lower than a thermal conductivity of the base.

8. The robot hand according to claim 7, further comprising a heat shielding member located between the saggar and the base when the saggar is held by the hand arm unit.

9. The robot hand according to claim 8, wherein the heat shielding member is attached to the base.

10. A robot comprising:
a robot arm; and
a robot hand attached to the robot arm and configured to hold a saggar conveyed out from a heat treatment furnace,
wherein the robot hand comprises:
a hand arm unit for holding the saggar, and
a cooling mechanism for cooling the hand arm unit.
